(19) United States
(12) Patent Application Publication
(10) Pub. No.: US 2024/0269767 A1
(43) Pub. Date: Aug. 15, 2024

(54) ULTRASONIC WELDING DEVICE COMPRISING A FORCE SENSOR

(71) Applicant: SCHUNK SONOSYSTEMS GMBH, Wettenberg (DE)

(72) Inventors: Stefan MÜLLER, Wetzlar (DE); Daniel GÜNTHER, Langgöns (DE)

(73) Assignee: SCHUNK SONOSYSTEMS GMBH, Wettenberg (DE)

(21) Appl. No.: 18/292,482

(22) PCT Filed: Jul. 28, 2021
(86) PCT No.: PCT/EP2021/071196

§ 371 Date: Jan. 26, 2024

(51) Int. Cl. B23K 20/26; B23K 20/10

(52) U.S. Cl. CPC B23K 20/26; B23K 20/106

(57) ABSTRACT

An ultrasonic welding device which includes a sonotrode arrangement, an anvil, a displacement device, and a force sensor. The sonotrode arrangement has a sonotrode head. The sonotrode arrangement is configured to transmit ultrasonic vibrations, which are generated at the sonotrode arrangement in a region remote from the sonotrode head, to the sonotrode head such that the sonotrode head vibrates in a vibration direction of the sonotrode arrangement and that the sonotrode arrangement vibrates minimally in the vibration direction at a zero-point position which is arranged spaced apart from the sonotrode head, based on the vibration direction. The displacement device is configured to displace the sonotrode arrangement and the anvil relative to one another in a displacement direction.

### FIELD

The present invention relates to an ultrasonic welding device and to a method for operating this ultrasonic welding device.

### BACKGROUND

For a wide variety of technical applications, it may be necessary to join two components together in a mechanically secure and/or electrically conductive manner. For example, it may be necessary for various purposes to join strands of cables together mechanically and in an electrically conductive manner. It is thus possible to produce wiring harnesses or cable looms, for example, which may be used to connect electrical consumers, inside a vehicle for example, to each other, to an energy source and/or to a control system in an electrically conductive manner.

So-called ultrasonic welding was developed to produce substance-to-substance bonds between electrically conductive components, providing them with high strength and good electrical conductivity. It is a special form of friction welding in which components to be welded, as joining partners, are brought into surface contact with one another and moved against each other under low pressure and high-frequency mechanical vibrations. The vibrations may be generated with the aid of a sonotrode arrangement in which ultrasonic vibrations with frequencies of typically 20 kHz to 50 kHz are generated and transmitted to at least one of the joining partners. Plastic flow then allows the joining partners to permeate or interlock with each other close to the surface without the materials of the joining partners necessarily melting. Ultrasonic welding may therefore be used to bond joining partners together with low impact, quickly and economically.

Ultrasonic welding may in particular also be used for welding metal joining partners, such as, for example, for welding multiple strands of cables together, for the welding compacting of individual wires within a strand, for welding one or more strands to contact elements, and/or for welding metal sheets. For this purpose, the joining partners are generally inserted into a receiving chamber of an ultrasonic welding device and then welded together between a sonotrode head of an ultrasonically vibrating sonotrode and an anvil.

In order to be able to exert ultrasonic vibrations on the joining partners to be welded during ultrasonic welding with the sonotrode arrangement, the sonotrode is typically mechanically coupled at one end to a vibration generator. Spaced apart from the vibration generator, the sonotrode has the sonotrode head. Ultrasonic vibrations generated by the vibration generator, for example by means of a converter, and optionally modified by means of a booster are typically transmitted over the elongate body of the sonotrode and/or additional components to the sonotrode head. By displacing the sonotrode and the anvil relative to one another toward one another and thus clamping the joining partners between them, the ultrasonic vibrations may be transmitted to the joining partners.

It has been observed that results of an ultrasonic welding operation may depend considerably, inter alia, on the forces exerted on the joining partners during said operation.

### SUMMARY

There may be a requirement for an ultrasonic welding device and for a method for operating this ultrasonic welding device which allow results of an ultrasonic welding operation to be improved. In particular, there may be a requirement for a corresponding ultrasonic welding device or for an operating method with the aid of which conditions that prevail during an ultrasonic welding operation may be monitored and/or regulated in such a manner that properties of a resulting weld, such as, for example, mechanical strength, electrical conductivity, etc. of a welded joint that connects the joining partners, may be improved.

Such a requirement may be met by the subject matter of the independent claims. Advantageous embodiments are defined in the dependent claims and the following description.

A first aspect of the invention relates to an ultrasonic welding device which comprises a sonotrode arrangement, an anvil, a displacement device and a force sensor. The sonotrode arrangement comprises in a distal region a sonotrode head. The sonotrode arrangement is configured to transmit ultrasonic vibrations, which are generated at the sonotrode arrangement in a region remote from the sonotrode head, to the sonotrode head such that the sonotrode head vibrates in a vibration direction of the sonotrode arrangement and that the sonotrode arrangement vibrates minimally in the vibration direction at a zero-point position which is arranged spaced apart from the sonotrode head, based on the vibration direction. The displacement device is configured to displace the sonotrode arrangement and the anvil relative to one another in a displacement direction. The force sensor is positioned in a contact region adjacent to the zero position and is configured in such a manner that, with the aid of the force sensor, forces which are exerted by the sonotrode arrangement on the force sensor parallel to the displacement direction may be measured.

According to a second aspect, a method for operating an ultrasonic welding device according to an embodiment of the first aspect of the invention is proposed. The method comprises at least the following steps:
determining a force exerted by the sonotrode arrangement on the force sensor,
operating the ultrasonic welding device taking account of the determined force.

Without limiting the scope of the invention in any way, ideas and possible features relating to embodiments of the invention may be considered to be based, inter alia, on the thoughts and findings described below.

Summarized broadly and briefly, a fundamental concept of the idea described herein may be seen as equipping an ultrasonic welding device with a possibility of measuring as precisely as possible forces that are exerted on joining partners during a welding operation, so that information about these forces may be used, for example, to optimize parameters that are used in the welding operation. It has been found that the desired force measurement may preferably be carried out with a force sensor which interacts with the sonotrode arrangement in the vicinity of a zero-point position because, with this positioning, inter alia, on the one hand the forces measured with the aid of the force sensor allow a sufficiently accurate conclusion to be drawn about the forces that actually act on the joining partners during the welding operation, and on the other hand the force sensor is not exposed to excessive vibrations.

Possible details of embodiments of the ultrasonic welding device described herein will be explained hereinbelow.

The ultrasonic welding device has a sonotrode arrangement. The sonotrode arrangement is designed to set a sonotrode head in ultrasonic vibrations. For this purpose, the sonotrode arrangement is typically composed of multiple components, in particular a vibration generator and a sonotrode. The vibration generator is arranged at a proximal end of the sonotrode arrangement and is provided for generating the ultrasonic vibrations. For this purpose, the vibration generator generally has a converter, which converts periodically varying electrical signals into mechanical vibrations. In many but not all cases, a booster is further provided in the vibration generator, with the aid of which booster the mechanical vibrations are modified before they are transmitted from the vibration generator to the sonotrode. In the vibration generator, the ultrasonic vibrations are generated in a vibration direction. Many ultrasonic welding devices are adapted to generate the ultrasonic vibrations as longitudinal vibrations, that is to say vibrations the vibration direction of which runs parallel to a direction of longitudinal extent of the sonotrode arrangement. A vibration amplitude of a vibration used mainly for the ultrasonic welding process runs in the direction of vibration propagation within the sonotrode arrangement. In the sonotrode, which is typically elongate, the mechanical vibrations are then guided to the sonotrode head, which may be situated, for example, close to a distal end of the sonotrode arrangement. As an alternative, ultrasonic welding devices may in principle also be configured to generate transverse vibrations.

Because the sonotrode arrangement is intended both to exert forces and to transmit the ultrasonic vibrations to joining partners, the various components of the sonotrode arrangement must typically be held, mounted and/or supported in a housing. So as not to excessively load either the mentioned components or the corresponding holder, mount or support, in particular as a result of the ultrasonic vibrations, use is here made of the fact that there are typically one or more positions along the sonotrode arrangement at which the sonotrode does not vibrate or at least vibrates significantly more weakly than in adjacent regions. Such positions are conventionally referred to as zero-point positions and constitute nodes in respect of the vibrations to be transmitted along the sonotrode arrangement. The holder, mount or support arranged at or close to such a zero-point position is frequently referred to as a zero-point bearing.

During the welding operation, the anvil serves as a counter-bearing for the joining partners which are subjected to force and set in vibration by the sonotrode head of the sonotrode arrangement. The anvil may here be displaced toward the sonotrode head or alternatively the sonotrode head may be displaced toward the anvil in or contrary to the displacement direction and subjected to force. As a further alternative, both the anvil and the sonotrode head may be displaced.

In order to weld the joining partners together, they are received in a receiving chamber between the sonotrode head and the anvil. The sonotrode head and the anvil are then moved relative to one another toward one another with the aid of the displacement device. For this purpose, the displacement device may have a suitable mechanism, hydraulic system, pneumatic system or the like for effecting the desired relative movement. Depending on the design of the ultrasonic welding device, one of the two components may be held in a static manner and the other component may be displaced in a displacement direction by the displacement device. Alternatively, both components may also be displaced. The displacement direction runs transverse, preferably perpendicular, to a surface of the sonotrode head with which the sonotrode head contacts the joining partners in order to transmit the ultrasonic vibrations thereto. The displacement direction generally runs transverse, in particular perpendicular, to the direction of longitudinal extent of the sonotrode arrangement.

In principle, it is conceivable to determine the forces exerted inside the ultrasonic welding device on the joining partners in various ways. For example, the forces effected by the displacement device could be measured directly. However, it has been observed in the case of this easily implementable approach that the forces measured in the displacement device often do not appear to correspond to the forces actually exerted on the joining partners. It is assumed that, for example, friction effects, adhesion effects (in particular in the form of so-called slip-stick effects), temporary tilting of components relative to other components and the like, as may occur in the case of the components moved by the displacement device during their displacement, lead to the forces effected by the displacement device not being transmitted completely and reproducibly to the joining partners.

As an alternative approach, it is therefore proposed for the ultrasonic welding device described herein to arrange a force sensor adjacent to the zero position of the sonotrode arrangement. The force sensor is here to be arranged within a limited contact region which is situated at the zero-point position or at a sufficiently small distance from this zero-point position.

The force sensor is to be positioned and configured in such a manner that, with the aid thereof, forces that are exerted by the sonotrode arrangement in a direction that runs parallel to the displacement direction may be measured. For this purpose, the force sensor may have a force-measuring surface, on which forces may be exerted. The force sensor may then generate a force-measuring signal in dependence on the exerted forces. The force sensor may be, for example, in direct or indirect contact with a surface of the sonotrode arrangement by means of its force-measuring surface. In particular, the force-measuring surface may interact directly or indirectly by way of intermediate components with a lateral surface of the sonotrode arrangement, which extends parallel to the propagation direction of the ultrasonic vibrations to be transmitted.

It should be noted here that not all the force transmitted by the sonotrode arrangement to the force sensor needs to be directed parallel to the displacement direction. Instead, this total force may also run at an angle to the displacement direction. However, the force sensor should be positioned and configured in such a manner that at least a portion of such a total force that is directed parallel to the displacement direction, that is to say a force component which is directed parallel to the displacement direction, of such a total force may also be measured.

The described arrangement of the force sensor in the contact region adjacent to the zero-point position of the sonotrode arrangement, and the manner in which forces transmitted by the sonotrode arrangement may be measured with the aid of this force sensor, may make possible various advantages.

In particular, it has been observed that measuring the forces that are exerted by the sonotrode arrangement on a force sensor arranged at the zero-point position thereof permits particularly accurate conclusions about the forces that are ultimately exerted by the sonotrode arrangement on the joining partners. This may result, inter alia, because typically no or few friction losses, adhesion losses due to slip-stick effects, tilting of components or the like occur between the position at which the force sensor interacts with the sonotrode arrangement and the position at which the sonotrode head interacts with the joining partners.

Furthermore, dimensions of the sonotrode arrangement are typically known very accurately. Accordingly, a distance between the position at which the force sensor interacts with the sonotrode arrangement and the position at which the sonotrode head interacts with the joining partners, for example, may be known very accurately. Thus, on the basis of the known dimensions, conclusions may be drawn, for example, about lever ratios within the ultrasonic welding device. Accordingly, the forces determined by the force sensor may be converted with high accuracy into forces as are exerted on the joining partners.

It has further been recognized that, although the ultrasonic vibrations which are transmitted along the longitudinal extent of the sonotrode arrangement and which are to set the sonotrode head in vibration in the vibration direction are minimal in the vibration direction at the zero-point position, it is entirely possible for considerable vibrations that oscillate in a direction transverse to the vibration direction to occur at the zero-point position. In other words, longitudinal vibrations which are transmitted along the sonotrode arrangement are minimal at the zero-point position, but radial vibrations or transverse vibrations directed perpendicular thereto may become considerable at the zero-point position. Such radial vibrations could also be referred to as contraction vibrations, because they are caused by a periodic transverse contraction of the sonotrode arrangement. Typically, the radial vibrations vibrate with a 180° phase shift relative to the longitudinal vibrations. Their amplitude is usually significantly smaller, that is to say, for example, only approximately a third, compared to the amplitude of the longitudinal vibrations. The radial vibrations are typically directed largely parallel to the above-described displacement direction of the displacement device and thus act on the force sensor as an oscillating force, wherein the force is directed substantially perpendicular to the force-measuring surface of the force sensor.

Because the radial vibrations correlate with the ultrasonic vibrations to be transmitted to the sonotrode head, information about the ultrasonic vibrations transmitted by the sonotrode head to the joining partners may be derived by measuring the forces effected by the radial vibrations. In particular, information about vibration frequencies, vibration amplitudes and/or other vibration properties may be derived. For example, a frequency of the radial vibrations is typically equal to the frequency of the ultrasonic vibrations transmitted to the joining partners, and a phase and/or an amplitude of the radial vibrations generally correlates in a predetermined manner with the corresponding values of the ultrasonic vibrations transmitted to the joining partners. This information may be helpful in influencing and/or evaluating a welding operation carried out with the aid of the ultrasonic welding device.

It has further also been observed that, when a force sensor is arranged at or close to the zero-point position of the sonotrode arrangement, it is loaded to a comparatively small extent by the ultrasonic vibrations to be transmitted along the sonotrode arrangement. This may have an advantageous impact on the specifications to be met by the force sensor and/or on a service life of the force sensor.

According to one embodiment, the contact region in which the force sensor is arranged on the sonotrode arrangement is to extend adjacent to the zero-point position in such a manner that, within the contact region, a maximum distance to the zero-point position is less than 20%, preferably less than 10% or less than 5%, of a distance between the zero-point position and a geometric center of the sonotrode head.

It has been recognized that it may be advantageous if the force sensor is arranged as close as possible to the zero-point position of the sonotrode arrangement. In particular, the position at which the force sensor interacts with the sonotrode arrangement, in relation to other dimensions of the sonotrode arrangement and in particular in relation to the distance between the zero-point position and the sonotrode head, is to be spaced apart as little as possible from the zero-point position. For example, the lateral distance, measured in the direction of extent of the sonotrode arrangement, between a geometric center of the force sensor and the zero-point position may typically be less than 20 mm, preferably less than 10 mm. This distance, mentioned by way of example, here relates to a sonotrode arrangement which is designed, for example, for ultrasonic vibrations in the region of 20 kHz and in which a lateral distance between the center of the sonotrode head and the zero-point position may be, for example, approximately between 60 mm and 70 mm. Sonotrode arrangements designed for higher frequencies are typically shorter and the mentioned distance is thus to be chosen to be smaller.

It may thus be achieved, inter alia, that vibrations, such as in particular longitudinal vibrations, which are exerted by the sonotrode arrangement on the force sensor in a direction in which the force sensor generally has low mechanical strength, are kept low. In addition, it may be achieved that vibrations, such as in particular radial vibrations, which may readily be detected by the force sensor and which optionally allow a conclusion to be drawn about the ultrasonic vibrations to be transmitted by the sonotrode arrangement, may be measured particularly well by the force sensor.

For example, the force sensor may be integrated in a zero-point bearing by way of which the sonotrode arrangement is supported or mounted at its zero-point position.

According to one embodiment, the sonotrode arrangement comprises a vibration generator and a sonotrode. The force sensor is here arranged on the sonotrode in a contact region adjacent to a zero-point position.

In other words, the sonotrode arrangement may broadly be divided into at least two parts. The vibration generator generates the ultrasonic vibrations, for example with a converter, and optionally modifies them with a booster. The generated ultrasonic vibrations are then transmitted to the sonotrode, wherein the sonotrode is typically in one piece between an interface with the vibration generator and the sonotrode head. One or more nodes may occur both at the vibration generator, in particular at the optional booster thereof, and at the sonotrode, and thus there may be one or more zero-point positions. It has been recognized as advantageous to arrange the force sensor that is to be used for the force measurement not at a zero-point position of the vibration generator but at a zero-point position on the sonotrode. For the force sensor which is arranged at such a zero-point position on the sonotrode, there is generally a very direct mechanical coupling with the sonotrode head by way of the typically one-piece sonotrode. Conclusions about forces and/or vibrations which are transmitted from the sonotrode to joining partners adjacent thereto may thus readily be drawn on the basis of the forces detected by the force sensor.

According to one embodiment, the ultrasonic welding device further comprises a bearing element which is interposed between a force-measuring surface of the force sensor and a surface of the sonotrode arrangement, wherein the bearing element contacts the force-measuring surface with at least a first surface and contacts the surface of the sonotrode arrangement with at least a second surface.

In other words, the force sensor may preferably not rest directly with its force-measuring surface against a surface of the sonotrode arrangement, but may interact with that surface indirectly by way of an intermediate bearing element. The bearing element may be configured to transmit vibrations, such as in particular ultrasonic vibrations, which from the sonotrode arrangement act on the bearing element at the second surface thereof, to the opposite first surface thereof in a modified manner to the force-measuring surface of the force sensor. In particular, the bearing element may be configured to filter ultrasonic vibrations that are present in respect of their frequency spectrum and/or to reduce them in respect of their amplitude.

It is thus possible to avoid, inter alia, overloading at the force sensor. On the other hand, provided that the elasticity properties and/or damping properties of the bearing element are sufficiently known, sufficiently accurate conclusions about the forces and/or vibrations acting in the sonotrode arrangement may be drawn on the basis of the forces that are measured by the force sensor and that optionally oscillate. For example, the bearing element may be formed of a glass-fiber composite. Such a bearing element may have a compressive strength perpendicular to a layer direction of about 500 MPa (measured in accordance with ISO 604) and/or a shear strength parallel to the layer direction of about 100 KJ/m² (measured in accordance with VDE 0318/2). It should be noted that the numerical values mentioned herein are to be understood only by way of example and in the sense of an order of magnitude. The bearing element may contact the sonotrode arrangement in the contact region adjacent to the zero-point position.

According to one embodiment, the bearing element may be more elastic than the sonotrode arrangement.

In other words, the bearing element, or a material of the bearing element, may have a lower modulus of elasticity than the sonotrode arrangement and in particular the sonotrode thereof, or the respective materials thereof. For example, a modulus of elasticity of the material of the bearing element may be about 22,000 MPa, measured by a bending test and in accordance with ISO 178 RT, wherein it should be noted that the numerical values mentioned herein are to be understood only by way of example and in the sense of an order of magnitude. Accordingly, although the bearing element may be substantially dimensionally stable when subjected to a (quasi)static force by the sonotrode arrangement, high-frequency vibrations may nevertheless be transmitted filtered to a certain extent by way of the bearing element.

According to one embodiment, the force sensor is arranged in such a manner that, when a pressure is exerted between the sonotrode head and the anvil, the force sensor is subjected to pressure by the sonotrode arrangement.

In other words, the force sensor should preferably be arranged on and interact with the sonotrode arrangement in such a manner that it is subjected to pressure under the forces which typically occur during operation of the ultrasonic welding device. Such a pressure load may in many cases be measured more easily and/or more precisely than a corresponding tensile load. The forces which typically occur during operation of the ultrasonic welding device in most cases result from the fact that the sonotrode head and the anvil are moved toward one another by the displacement device in order to contact the joining partners received between them and press them together at least slightly. Generally, a force is exerted on the sonotrode head that is directed away from the anvil and that is transmitted over the portion of the sonotrode that is adjacent thereto to the force sensor arranged at the zero-point position of the sonotrode.

As explained hereinbefore, in the ultrasonic welding device described herein, forces which act on the sonotrode may be determined with the aid of the force sensor. The determined forces then allow conclusions to be drawn about the forces that are exerted between the sonotrode head and the anvil on the joining partners enclosed therebetween. In particular, forces having an oscillating action may also be determined. Because the forces and vibrations acting on the joining partners during a welding operation may have a considerable influence on the welding of the joining partners, the signals determined by the force sensor may therefore be used to advantageously influence the welding of the joining partners.

For this purpose, the ultrasonic welding device according to one embodiment may further comprise a closed-loop control device which is configured to regulate properties of the ultrasonic welding device taking account of signals of the force sensor. The ultrasonic welding device may then be operated in such a manner that properties of the ultrasonic welding device are regulated taking account of the force determined by the force sensor.

Expressed differently, the signals or force measurements delivered by the force sensor may be used not only to control but also to regulate one or more properties of the ultrasonic welding device.

In conventional ultrasonic welding devices, properties which influence a welding operation are generally controlled only by a control system. The control system specifies target parameters, but does not take account of whether the properties of the ultrasonic welding device actually come about in accordance with those target parameters. By contrast, in the case of the ultrasonic welding device proposed here, it is to be made possible that the properties influencing the welding operation are regulated taking account of the signals from the force sensor, wherein these signals provide sufficiently reliable and/or precise information about which properties actually come about in the ultrasonic welding device and whether they follow the target parameters in the desired way.

For example, according to one embodiment the closed-loop control device may be configured to regulate a force generated by means of the displacement device between the sonotrode arrangement and the anvil taking account of the signals of the force sensor. The ultrasonic welding device may then be operated in such a manner that a force which is generated by means of the displacement device between the sonotrode arrangement and the anvil is regulated taking account of the force determined by the force sensor.

Expressed differently, a force with which, for example, a mechanism, hydraulic system, pneumatic system, an electric servo drive or the like of the displacement device moves the sonotrode arrangement and the anvil toward one another may be controlled not only by specifying a target force, as is usually the case in conventional ultrasonic welding devices. Instead, the force determined by the force sensor may be taken into account when setting that force. While it is not possible in the conventional force setting specified only in a controlled manner to recognize what forces are actually effected on the joining partners on displacement of the displacement device, it is possible by taking account of the forces determined by the force sensor to draw conclusions about the forces actually acting on the joining partners. Accordingly, the displacement device may be regulated in a suitable manner by the closed-loop control device, so that these forces that actually act may be set in accordance with target specifications. For example, a relative position set by the displacement device between the sonotrode head and the anvil and a force thereby effected on the joining partners may be re-adjusted if it changes, for example, in an undesired manner during a welding operation, for example as a result of slip-stick effects and/or tilting that resolve themselves.

According to a further embodiment, the closed-loop control device may be configured to regulate ultrasound generation in the sonotrode arrangement taking account of the signals of the force sensor. The ultrasonic welding device may then be operated in such a manner that ultrasound generation in the sonotrode arrangement is regulated taking account of the time-varying force determined by the force sensor.

In other words, on the basis of the signals generated by the force sensor and the determined force represented thereby, it may be concluded what forces actually act on the joining partners during the welding operation. A temporal resolution of changes in this force progression may be sufficiently high to permit conclusions about the ultrasonic vibrations transmitted to the joining partners. These ultrasonic vibrations at the joining partners may change during a welding operation in dependence on the exerted forces and/or in dependence on the ultrasonic vibrations generated by the vibration generator. In particular, the measured forces may be caused by the above-described radial vibrations of the sonotrode arrangement at its zero-point position and thus vary over time in the ultrasonic frequency range. Such changes may be recognized on the basis of the force measurement by the force sensor, so that, on the basis of the signals of the force sensor, feedback may be transmitted to the closed-loop control device. On the basis of this feedback, the closed-loop control device may then regulate the generation of the ultrasonic vibrations, for example by suitably adapting control signals to the vibration generator. Influencing factors which influence a result of the welding operation, such as, for example, a vibration frequency and/or a vibration amplitude, may thus advantageously be modified and optimized as far as possible.

According to a further embodiment, the ultrasonic welding device may further comprise a monitoring device which is configured to determine information about a current state of the ultrasonic welding device on the basis of signals of the force sensor. The ultrasonic welding device may here be operated in such a manner that information about its current state is determined and outputted taking account of the force determined by the force sensor.

Use may here be made, inter alia, of the fact that it has been observed that the forces measured by the force sensor, and in particular a progression of these forces over time, allow conclusions to be drawn about the current state of the ultrasonic welding device. For example, a way in which the force progression measured by the force sensor behaves while the sonotrode and the anvil are being moved toward one another by the displacement device and thus clamp the joining partners between them may give an indication of current physical properties within the ultrasonic welding device. For example, abrupt changes or jumps within that force progression may indicate the mechanical state of the ultrasonic welding device. Corresponding information about the current state of the ultrasonic welding device may be outputted or transmitted, for example, as signals to other internal or external components, in order, for example, to be able to adapt the operation of the ultrasonic welding device on the basis thereof and/or in order, for example, to be able to provide appropriate corrective actions in the case of a defective state.

It should be noted that possible features and advantages of embodiments of the invention are explained herein partly with reference to an ultrasonic welding device and partly with reference to an operating method for an ultrasonic welding device. A person skilled in the art will recognize that the features described for individual embodiments may be suitably transferred to other embodiments in an analogous manner, may be adapted and/or interchanged to arrive at further embodiments of the invention and possibly synergistic effects.

### BRIEF DESCRIPTION OF THE DRAWINGS

Advantageous embodiments of the invention are further explained below with reference to the accompanying drawings, and neither the drawings nor the explanations are to be construed as limiting the invention in any way.

FIG. 1 shows a schematic representation of an ultrasonic welding device according to an exemplary embodiment of the invention.

FIG. 2 shows a more detailed cross-sectional view through components of the ultrasonic welding device of FIG. 1.

FIG. 3 shows an example of a progression of a force progression, as may be determined in an ultrasonic welding device according to the invention.

The figures are merely schematic and not to scale. Identical reference signs in the various drawings denote identical features or features having the same effect.

### DETAILED DESCRIPTION

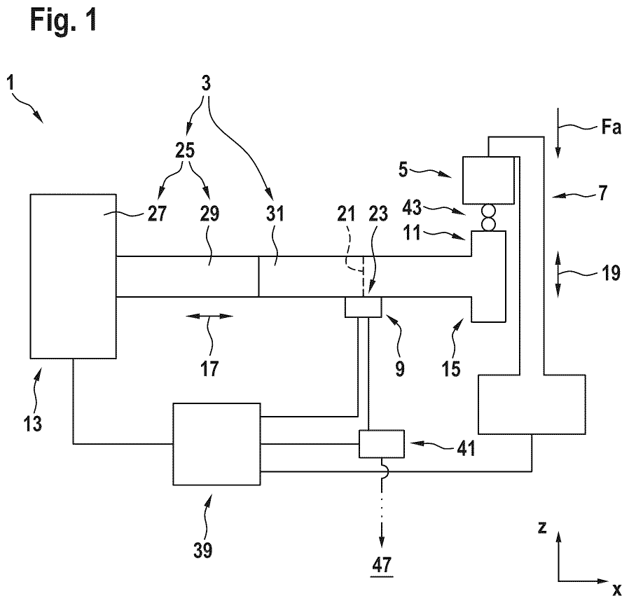

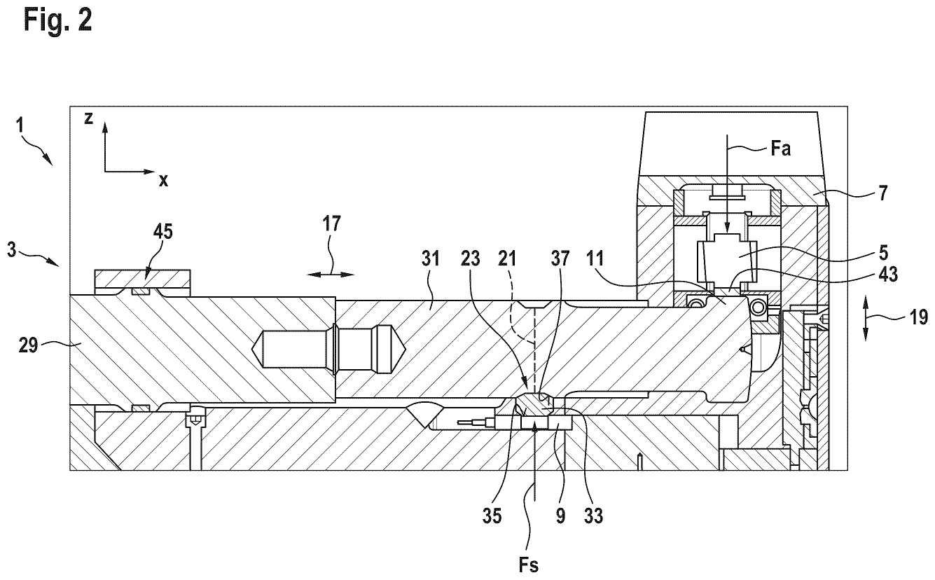

FIG. 1 shows a highly schematic representation of an embodiment of an ultrasonic welding device 1. Some details of the ultrasonic welding device 1 are shown in FIG. 2.

The ultrasonic welding device 1 has a sonotrode arrangement 3, an anvil 5, a displacement device 7, and a force sensor 9. The sonotrode arrangement 3 has in a proximal region 13 a vibration generator 25 having a converter 27 and a booster 29, for generating ultrasonic vibrations in a vibration direction 17, which is denoted the x-direction herein. In the example shown, longitudinal vibrations are generated, that is to say the vibration direction 17 is substantially parallel to a longitudinal extent of the sonotrode arrangement 3. The sonotrode arrangement 3 further has a sonotrode 31, which in a distal region 15 has a sonotrode head 11. In order to be able to absorb reaction forces, the sonotrode arrangement 3 is both mounted on a zero-point bearing 45 at the booster 29 and supported at a zero-point position 21 on the sonotrode 31.

The anvil 5 is situated above the sonotrode head 11. Joining partners 43, for example in the form of two or more strands or cables, may be received between the anvil 5 and the sonotrode head 11.

With the aid of the displacement device 7, the anvil 5 and the sonotrode arrangement 3 with its sonotrode head 11 may be moved relative to one another in a displacement direction 19. The displacement direction 19 is denoted the z-direction herein. In the example shown, the displacement device 7 may be in the form of an anvil drive and may have, for example, a servo drive or a pneumatic cylinder for moving the anvil 5 with a force Fa.

The force Fa may optionally be measured. However, it has been observed that the force Fa effected by the displacement device 7 does not necessarily correspond to the force that occurs at the sonotrode 31 or that acts on the joining partners 43. Force losses may occur, for example, as a result of friction and noise, and these force losses may not be recognized by measuring the force Fa. Expressed differently, the drive force Fa of the displacement device 7 may be influenced, for example, by friction in guides and/or the welding material. Furthermore, it has been observed that, generally, no reliable relationship is recognizable between amplitude, frequency and force, and thus this may not reliably be taken into account.

In order better to be able to determine the forces actually acting on the joining partners 43 and possibly also the ultrasonic vibrations exerted on the joining partners 43, the ultrasonic welding device 1 has the force sensor 9. The force sensor 9 is positioned in a contact region 23 adjacent to the zero-point position 21 of the sonotrode 31. The force sensor 9 is configured to be able to measure forces Fs which are exerted thereon by the sonotrode 31 of the sonotrode arrangement 3. These forces Fs act at least with one of their force components in a direction parallel to the displacement direction 19 in which the sonotrode 31 is subjected to force by the displacement device 7 indirectly by way of the anvil 5 owing to the forces Fa exerted there.

The force sensor 9 so arranged and configured thus detects forces Fs, or a progression over time of such forces Fs, which correlate significantly more directly with the forces acting on the joining partners 43, or with the associated force progression, than is the case with the forces Fa measured at the displacement device 7.

The force sensor 9 is arranged within the contact region 23 in the vicinity of the zero-point position 21 of the sonotrode 31. This contact region 23 is dimensioned in such a manner that the force sensor 9 is sufficiently close to the zero-point position 21. The force sensor 9 is thus scarcely loaded by longitudinal vibrations, because these are minimal at the zero-point position 21. On the other hand, the force sensor 9 may be subjected to force owing to radial vibrations within the sonotrode 31. Such radial vibrations occur as transverse contractions in particular at the zero-point position 21 due to time-varying local compressions within the sonotrode 31 that correlate with the longitudinal vibrations, so that the sonotrode 31 appears to “pump” with its lateral surface in the region of the zero-point position 21.

With the aid of the force sensor 9, the forces acting on the sonotrode 31 at the zero-point position 21 thereof may thus be determined with high accuracy. There is generally a direct correlation between those forces and the forces that actually act on the joining partners 43. In addition, the progression over time of those forces may be recorded. Accordingly, in particular the transverse contraction of the sonotrode 31 at the zero point thereof may be determined, and information about the longitudinal vibrations by the sonotrode arrangement 3, in particular the frequency, amplitude and/or phase thereof, may be derived therefrom. The determined information may be used for regulating and/or monitoring the ultrasonic welding device 1.

A bearing element 33 is interposed between a force-measuring surface 35 of the force sensor 9 and an opposite surface 37 of the sonotrode 31. The bearing element 33 is intended to protect the force sensor 9, inter alia, against overloading, in particular against overloading owing to transmitted longitudinal vibrations and/or excessive radial vibrations from the sonotrode 31. An adequate service life for the force sensor 9 may thus be achieved.

On the other hand, the bearing element 33 is to be configured in such a manner that it does not excessively influence the forces Fs to be measured and the progression over time thereof, so that, for example, the amplitude and/or phase of said forces still correlate sufficiently accurately with the associated parameters, as prevail in the sonotrode 31.

The force sensor 9 and the bearing element 33 may on the one hand be supported on a housing of the ultrasonic welding device 1 and on the other hand support the sonotrode 31 at its zero-point position 21. Overall, a kind of zero-point bearing for the sonotrode 31 may thus be formed by way of the force sensor 9 and the bearing element 33, wherein forces Fs prevailing there may be determined by the force sensor 9.

Signals which are generated by the force sensor 9 in response to the determined forces Fs may then be fed to a closed-loop control device 39 and/or a monitoring device 41.

The closed-loop control device 39 may purposively regulate properties and/or functions of the ultrasonic welding device 1 on the basis of those signals.

For example, the forces Fa generated by means of the displacement device 7 between the sonotrode 31 and the anvil 5 may be regulated taking account of the signals of the force sensor 9. The forces that actually act on the joining partners 43 may thus be adjusted better than was the case in conventional ultrasonic welding devices.

Furthermore, the closed-loop control device 39 may use the signals of the force sensor 9 to regulate the converter 27 of the sonotrode arrangement 3 in a suitable manner, in order to effect a desired ultrasound generation in the sonotrode arrangement 3.

The monitoring device 41 may use the signals received from the force sensor 9 to determine information about a current state of the ultrasonic welding device 1. For example, abrupt changes in the progression of the measured force Fs, that is to say jumps in the force, for example when switching on or switching off the generation of the ultrasonic vibrations, may allow a conclusion to be drawn about a current mechanical state of the ultrasonic welding device 1 and its components.

The monitoring device 41 may forward the information about the current state of the ultrasonic welding device 1 to the closed-loop control device 39, for example, so that the information may be taken into account there. Alternatively or in addition, such information may also be forwarded to other internal or external components 47. For example, the information may be shown on a display, in order to allow a technician to recognize malfunctions or wear phenomena and initiate appropriate counter-measures.

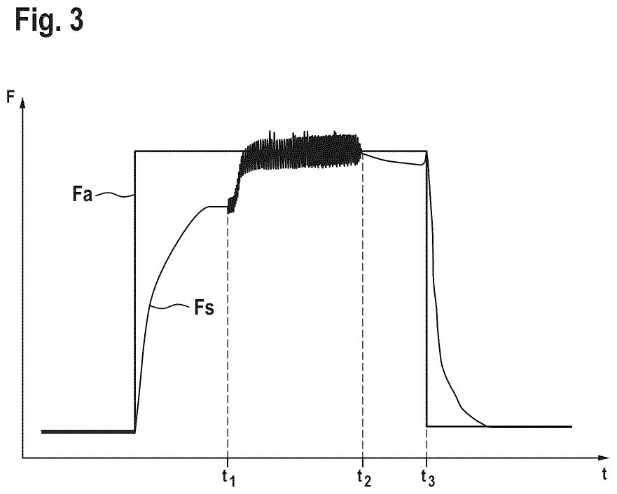

FIG. 3 shows by way of example a progression of a force F in dependence on time t. There are shown on the one hand the force Fa measured directly at the displacement device 7 and on the other hand the force Fs determined by the force sensor 9.

As may clearly be seen, the progressions over time of the two forces Fa and Fs differ significantly. The force Fa effected at the displacement device 7 follows a control signal and has a substantially rectangular progression.

However, the force Fs which then acts on the sonotrode 31, and thus also the force acting substantially on the joining partners 43, may differ significantly from such a rectangular progression. Initially, this force Fs firstly increases sharply, but then appears to reach a maximum value.

As soon as the generation of the ultrasonic vibrations is started at time t1, the measured force Fs again increases for a short time. It is supposed that this is because previously existing tilting, adhesions or the like may resolve themselves under the influence of the ultrasonic vibrations. It may further be seen that the measured force Fs oscillates following the ultrasonic vibrations, wherein oscillation parameters such as a vibration frequency, a vibration amplitude and/or a vibration phase appear to correlate with the ultrasonic vibrations prevailing in the sonotrode 31.

When the generation of the ultrasonic vibrations is terminated at time t2, the measured force Fs slowly decreases.

From time t3, the measured force then decreases again sharply and ultimately reaches substantially the level which prevailed prior to the ultrasonic welding operation.

With the ultrasonic welding device 1 described herein and the way in which this may be operated in a regulated manner, an improvement in ultrasonic welding processes may be achieved, in particular in the case of joining partners which are difficult to weld or contaminated joining partners. Potentially defective welded joints may be avoided and/or recognized.

Finally, it should be noted that terms such as “having”, “comprising”, etc. do not exclude any other elements or steps and the term “one” does not exclude a plurality. It should further be pointed out that features or steps which have been described with reference to one of the above exemplary embodiments may also be used in combination with other features or steps of other exemplary embodiments described above. Reference signs in the claims are not to be regarded as a limitation.

### LIST OF REFERENCE SIGNS

1 Ultrasonic welding device
3 Sonotrode arrangement
5 Anvil
7 Displacement device
9 Force sensor
11 Sonotrode head
13 Proximal region
15 Distal region
17 Vibration direction
19 Displacement direction
21 Zero-point position
23 Contact region
25 Vibration generator
27 Converter
29 Booster
31 Sonotrode
33 Bearing element
35 Force-measuring surface
37 Surface of the sonotrode arrangement
39 Closed-loop control device
41 Monitoring device
43 Joining partner
45 Zero-point bearing of the booster
47 External component
Fa Force by the displacement device
Fs Force on force sensor
x x-direction
z z-direction

1.-15. (canceled)

16. An ultrasonic welding device, comprising:
a sonotrode arrangement,
an anvil,
a displacement device, and
a force sensor,
wherein the sonotrode arrangement comprises a sonotrode head,
wherein the sonotrode arrangement is configured to transmit ultrasonic vibrations,
which are generated at the sonotrode arrangement in a region remote from the sonotrode head, to the sonotrode head such that the sonotrode head vibrates in a vibration direction of the sonotrode arrangement and that the sonotrode arrangement vibrates minimally in the vibration direction at a zero-point position which is arranged spaced apart from the sonotrode head, based on the vibration direction,
wherein the displacement device is configured to displace the sonotrode arrangement and the anvil relative to one another in a displacement direction,
wherein the force sensor is positioned in a contact region adjacent to the zero-point position and is configured in such a manner that, with the aid of the force sensor, forces which are exerted by the sonotrode arrangement on the force sensor parallel to the displacement direction may be measured.

17. The ultrasonic welding device as claimed in claim 16,
wherein the contact region extends adjacent to the zero-point position and within the contact region a maximum distance to the zero-point position is less than 20% of a distance between the zero-point position and a geometric center of the sonotrode head.

18. The ultrasonic welding device as claimed in claim 16,
wherein the sonotrode arrangement comprises a vibration generator and a sonotrode, and wherein the force sensor is arranged on the sonotrode in a contact region adjacent to a zero-point position.

19. The ultrasonic welding device as claimed in claim 16,
further comprising a bearing element which is interposed between a force-measuring surface of the force sensor and a surface of the sonotrode arrangement, wherein the bearing element contacts the force-measuring surface of the force sensor with a first surface and contacts the surface of the sonotrode arrangement with a second surface.

20. The ultrasonic welding device as claimed in claim 19,
wherein the bearing element is more elastic than the sonotrode arrangement.

21. The ultrasonic welding device as claimed in claim 16,
wherein the force sensor is arranged in such a manner that, when a pressure is exerted between the sonotrode head and the anvil, the force sensor is subjected to pressure by the sonotrode arrangement.

22. The ultrasonic welding device as claimed in claim 16,
further comprising a closed-loop control device which is configured to regulate properties of the ultrasonic welding device taking account of signals of the force sensor.

23. The ultrasonic welding device as claimed in claim 22,
wherein the closed-loop control device is configured to regulate a force generated by means of the displacement device between the sonotrode arrangement and the anvil taking account of the signals of the force sensor.

24. The ultrasonic welding device as claimed in claim 22,
wherein the closed-loop control device is configured to regulate ultrasound generation in the sonotrode arrangement taking account of the signals of the force sensor.

25. The ultrasonic welding device as claimed in claim 16,
further comprising a monitoring device which is configured to determine information about a current state of the ultrasonic welding device on the basis of signals of the force sensor.

26. A method for operating an ultrasonic welding device as claimed in claim 16, wherein the method comprises:
determining a force exerted by the sonotrode arrangement on the force sensor,
operating the ultrasonic welding device taking account of the determined force.

27. The method as claimed in claim 26,
further comprising:
regulating properties of the ultrasonic welding device taking account of the determined time-varying force.

28. The method as claimed in claim 26,
further comprising:
regulating a force generated by means of the displacement device between the sonotrode arrangement and the anvil taking account of the determined force.

29. The method as claimed in claim 26,
further comprising:
regulating ultrasound generation in the sonotrode arrangement taking account of the determined force.

30. The method as claimed in claim 26,
further comprising:
determining and outputting information about a current state of the ultrasonic welding device taking account of the determined force.
